(19) United States
(12) Patent Application Publication
(10) Pub. No.: US 2011/0004985 A1
(43) Pub. Date: Jan. 13, 2011

(54) Ceramic Hinge

(76) Inventor: Gosakan Aravamudan, Karnataka (IN)

Correspondence Address: ASHOK TANKHA, 36 GREENLEIGH DRIVE, SEWELL, NJ, 08080, US

(21) Appl. No.: 12/922,913

(22) PCT Filed: Mar. 16, 2009
(86) PCT No.: PCT/IN2009/000182

§ 371 Date: Sep. 16, 2010

(30) Foreign Application Priority Data
Mar. 18, 2008 (IN) 667/CHE/2008

(51) Int. Cl. A62B 17/00; E05D 9/00; C04B 35/64

(52) U.S. Cl. 2/458; 16/385; 264/607

(57) ABSTRACT

Disclosed herein is a method of manufacturing a ceramic hinge to connect two ceramic bodies, comprising the steps of: shaping a separation insert in the form of a hinge, introducing the separation insert into a ceramic body, thereby separating the ceramic body into a first part and a second part; and heating the ceramic body and the separation insert of the ceramic body up to the sintering temperature of the ceramic body. The separation insert creates either a cavity in the case of a combustible insert or a soft pad in the case of a ceramic fiber based insert within the ceramic body. This cavity or soft pad allows a hinge or rotary movement between the first part and the second part of the ceramic body. The first part and the second part of the ceramic body can therefore freely rotate or hinge around one another.

### CROSS REFERENCE TO RELATED APPLICATIONS

This application claims the benefit of the following patent applications:
1. Provisional patent application number 667/CHE/2008 titled “Ceramic Hinge”, filed on Mar. 18, 2008 in the Indian Patent Office.
2. PCT application number PCT/IN2009/000182 titled “Ceramic Hinge And Connected Ceramic Plates”, filed on Mar. 16, 2009 in the Indian Patent Office.
   The specifications of the above referenced patent applications are incorporated herein by reference in their entirety.

### BACKGROUND

This invention, in general, relates to ceramic structures. More particularly, this invention relates to manufacture and use of a hinge in-situ in a ceramic body.

### SUMMARY OF THE INVENTION

This summary is provided to introduce a selection of concepts in a simplified form that are further described in the detailed description of the invention. This summary is not intended to identify key or essential inventive concepts of the claimed subject matter, nor is it intended for determining the scope of the claimed subject matter.

Disclosed herein is a method of manufacturing an in-situ ceramic hinge to connect two ceramic bodies, comprising the steps of: shaping a separation insert in the form of a hinge, introducing the separation insert into a ceramic body, thereby separating the ceramic body into a first part and a second part; and heating the ceramic body and the separation insert of the ceramic body up to the sintering temperature of the ceramic body. The separation insert creates either a cavity in the case of a combustible insert or a soft pad in the case of a ceramic fiber based insert within the ceramic body. This cavity or soft pad allows a hinge or rotary movement between the first part and the second part of the ceramic body. The first part and the second part of the ceramic body can therefore freely rotate or hinge around one another. Furthermore, disclosed herein are composite structures manufactured using in-situ ceramic hinges that are applied in furniture, building material, load bearing, fire safety, and impact resistant safety applications.

### BRIEF DESCRIPTION OF THE DRAWINGS

The foregoing summary, as well as the following detailed description of the invention, is better understood when read in conjunction with the appended drawings. For the purpose of illustrating the invention, exemplary constructions of the invention are shown in the drawings. However, the invention is not limited to the specific methods and instrumentalities disclosed herein.

FIG. 1 illustrates a method of manufacturing an in-situ ceramic hinge to connect two ceramic bodies.

FIG. 2 exemplarily illustrates a side view of a hinge.

FIG. 3 exemplarily illustrates a top view of a hinge.

FIG. 4A exemplarily illustrates the side view of a hinge rotation.

FIG. 4B exemplarily illustrates an angled top view of a hinge rotation.

FIG. 5 exemplarily illustrates a ceramic body comprising multiple ceramic plates connected with in-situ manufactured hinges.

FIG. 6 exemplarily illustrates a ceramic body comprising multiple ceramic plates connected with in-situ manufactured hinges, and backed by a resin bonded high strength fiber layer.

### DETAILED DESCRIPTION OF THE INVENTION

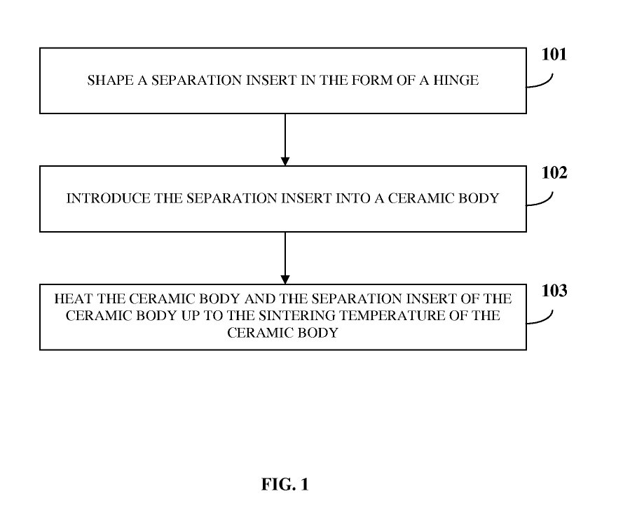

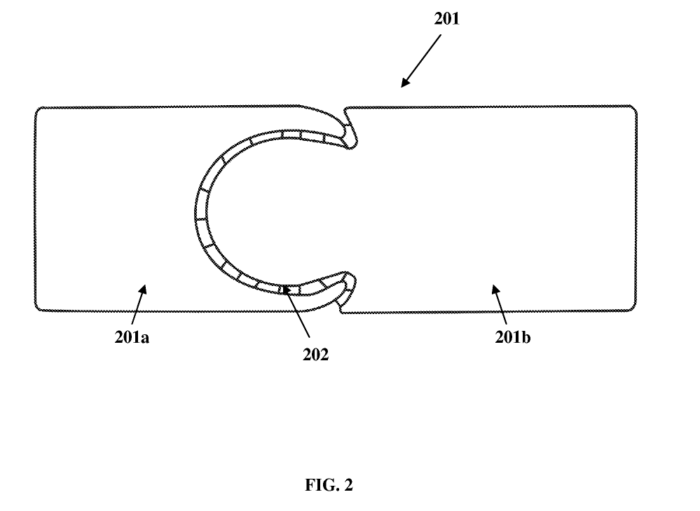

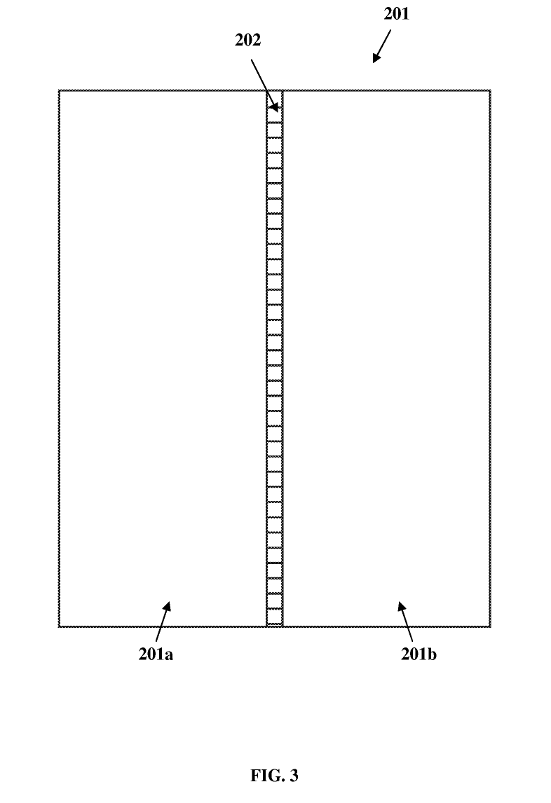

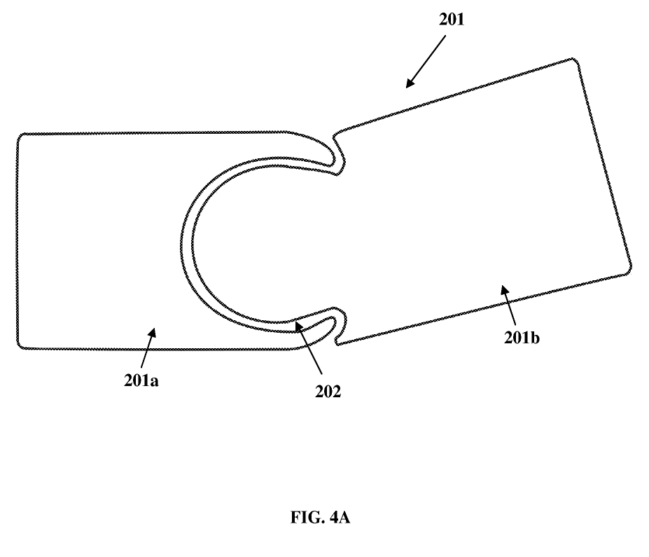

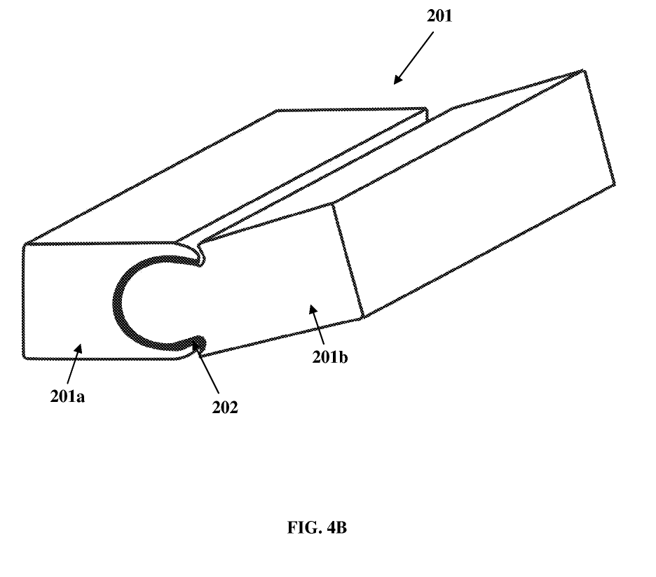

FIG. 1 illustrates the method of manufacturing an in-situ ceramic hinge to connect two ceramic bodies. A separation insert 202 is shaped 101 in the form of a hinge. FIG. 2 exemplarily illustrates a side view of the hinge. FIG. 3 exemplarily illustrates a top view of the hinge. The separation insert 202 is made of a material, for example, paper, cloth, etc. that is burnt out during the sintering cycle. The separation insert 202 is then introduced 102 into a ceramic body 201, thereby separating the ceramic body 201 into a first part 201a and a second part 201b. The ceramic body 201 and the separation insert 202 of the ceramic body 201 are heated 103 up to the sintering temperature of the ceramic body 201. The separation insert 202 comprises, for example, a ceramic fiber paper and a ceramic cloth that is left out as fibers after the heating operation, and that serves as a cushioned padding in the hinge. The first part 201a and the second part 201b of the ceramic body 201 can freely rotate or hinge around one another. The side view of the hinge rotation is exemplarily illustrated in FIG. 4A. An angled top view of the hinge rotation is exemplarily illustrated in FIG. 4B.

The separation insert 202 that contours the external shape of a hinge is provided in a green or unfired ceramic body 201. Examples of the separation insert 202 include either combustible inserts or non combustible inserts. The separation insert 202 creates a discontinuous phase in the sintered ceramic matrix. Inserts that are non combustible include separators made from ceramic fibers, such as ceramic paper which includes ceramic fibers and binders. Examples of combustible inserts include paper, cloth, etc. The green body along with its separation insert 202 is fired in a furnace. The separation insert 202 creates either a cavity in the case of a combustible insert or a soft pad in the case of ceramic fiber based insert within the ceramic body 201. The cavity or soft pad allows a hinge or rotary movement between the two ceramic structures.

### Example 1

A ceramic paper, for example, comprising alumina fibers and polyvinyl alcohol as a binder, is shaped as a hinge and placed in the mold, and takes a form as illustrated in FIG. 2 and FIG. 3. A ceramic mix is then introduced to completely fill the mold, allowing no air pockets in the mold. An example of such a mix comprises by weight feldspar (45% by weight), dolomite (25%), china clay (5%), ball clay (5%), quartz powder (5%), talc (5%) and wolcolstonite (5%). The polyvinyl alcohol within the ceramic paper burns out during the firing process. The composite is composite is fired up to 1120 degree centigrade. The ceramic fibers act as a soft padding for the hinge. The first part 201a and the second part 201b of the ceramic body 201 freely rotate as illustrated in FIG. 4A and FIG. 4B.

### Example 2

A cellulose based paper is shaped as a hinge, and placed in a mold. A ceramic mix, as explained in example 1, is then introduced to completely fill the mold, allowing no air pockets in the mold. The composite is fired up to 1120 degree centigrade. The cellulosic paper burns out during the firing process. The cavity enables the hinge operation.

The ceramic hinge has multiple industrial applications. The ceramic hinge can be used to create flexible ceramic structure that can be used in furniture, building material, load bearing applications, and impact resistant safety applications.

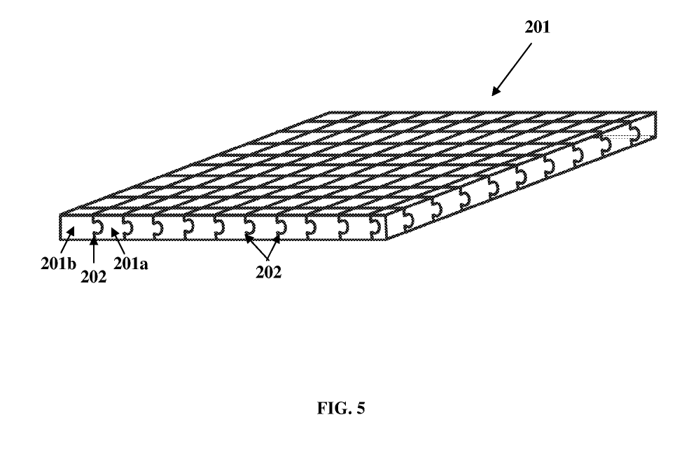

A fire resistant body suit can be constructed with these flexible ceramic plates connected with in-situ ceramic hinges. FIG. 5 exemplarily illustrates a ceramic body 201 comprising multiple ceramic plates connected with in-situ manufactured hinges. There is no combustible material in such a body.

A grid of separation inserts 202 are placed in a mold and a ceramic mix is introduced, thereby filling the mold. The mix may be introduced in a liquid or semi liquid form and dried slowly thereafter, thereby eliminating air pockets in proximity to the inserts 202. An example of such a mix comprises by weight feldspar (45% by weight), dolomite (25%), china clay (5%), ball clay (5%), quartz powder (5%), talc (5%) and wolcolstonite (5%). The composite is then fired in a furnace, and sinters at 1120 degree C. The resulting ceramic body 201 comprises multiple ceramic plates that are attached to each other via hinges, thereby forming an overall flexible ceramic body 201. The set of ceramic plates is interconnected through ceramic hinges. A flexible resin system may be introduced in the cavity formed by the burnt out inserts 202. An example of such a flexible resin is a silicon rubber based formulation. The resulting composite is therefore a flexible ceramic body 201 that flexes around the hinge lines. This composite can be used as core bodies for furniture structures. For example, laminates can be introduced on the surfaces of such a composite, and the resulting slab can be used as tabletops or doors.

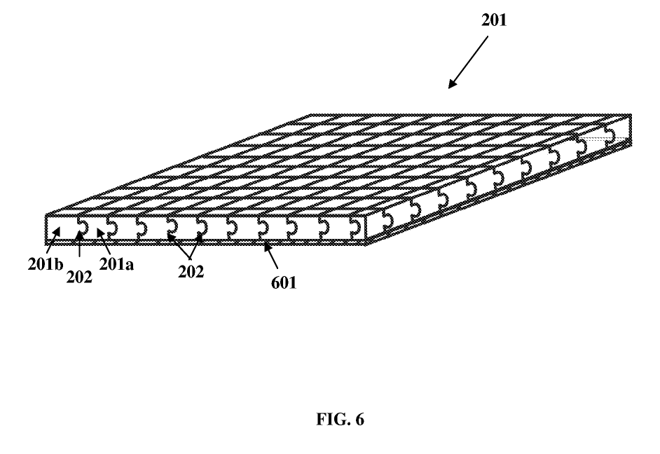

A grid of separation inserts 202 are placed in a mold and a ceramic mix is introduced, thereby filling the mold. Examples of the ceramic mix include alumina, silicon carbide, or silicon boride. The mix may be introduced in a liquid or semi liquid form and dried slowly thereafter, thereby eliminating air pockets in proximity to the inserts 202. The composite is then fired in a furnace. The resulting ceramic body 201 consists of multiple ceramic plates that are attached to each other via hinges, thereby forming an overall flexible ceramic body 201. A flexible resin system may be introduced in the cavity formed by the burnt out inserts 202. Example of such a flexible resin is a silicon rubber based formulation. The resulting composite is therefore a flexible ceramic body 201 that flexes around the hinge lines. A layer of high strength fibers, such as aramid, polyamide, glass, polyolefin, carbon, metal, boron or ceramic fibers may be applied as a backing to one or more surfaces of the above composite to create an impact resistant body structure. These high strength fibers are attached to the ceramic surface through a thermosetting or thermoplastic material. Such a material may be in liquid or powder form, and the adhesive process can be a wet lay up process or a heat based setting process. Such an impact resistant structure can be used in personal safety applications, as well as barriers in commercial landscapes. A ceramic body 201 comprising multiple ceramic plates connected with in-situ manufactured hinges, and backed by a resin bonded high strength fiber layer 601 is exemplarily illustrated in FIG. 6.

The foregoing examples have been provided merely for the purpose of explanation and are in no way to be construed as limiting of the present invention disclosed herein. While the invention has been described with reference to various embodiments, it is understood that the words, which have been used herein, are words of description and illustration, rather than words of limitation. Further, although the invention has been described herein with reference to particular means, materials and embodiments, the invention is not intended to be limited to the particulars disclosed herein; rather, the invention extends to all functionally equivalent structures, methods and uses, such as are within the scope of the appended claims. Those skilled in the art, having the benefit of the teachings of this specification, may effect numerous modifications thereto and changes may be made without departing from the scope and spirit of the invention in its aspects.

I claim:

1. A method of manufacturing a ceramic hinge to connect two ceramic bodies, comprising the steps of:
shaping a separation insert in the form of a hinge;
introducing said separation insert into a ceramic body, thereby separating said ceramic body into a first part and a second part; and
heating the ceramic body and the separation insert of the ceramic body up to the sintering temperature of the ceramic body;
whereby said first part and said second part of the ceramic body can freely rotate or hinge around one another.

2. The method of claim 1, wherein the separation insert is made of a material that is burnt out during the sintering cycle, wherein said material is one of a paper and a cloth.

3. The method of claim 1, wherein the separation insert comprises one of a ceramic fiber paper and a ceramic cloth that is left out as fibers after said heating operation, and that serves as a cushioned padding in said hinge.

4. A body of a furniture, building structure or load bearing structure, comprising:
a set of ceramic plates interconnected through ceramic hinges; and
a flexible resin introduced in a cavity around said ceramic hinges.

5. The body of claim 4, wherein said flexible resin is a silicone rubber.

6. A body of a furniture, building structure or load bearing structure, comprising:
a set of ceramic plates interconnected through ceramic hinges;
a flexible resin introduced in a cavity around said ceramic hinges; and
a layer of high strength fibers in a resin matrix bonded to one or more surfaces of the ceramic plates.

7. The body of claim 6, wherein said high strength fibers is one of aramid, polyamide, glass, polyolefin, carbon, metal, boron, ceramic fibers, and a combination thereof.

8. A fire resistant body suit, comprising flexible ceramic plates connected with in-situ ceramic hinges.
